(19) United States
(12) Patent Application Publication
(10) Pub. No.: US 2019/0249492 A1
(43) Pub. Date: Aug. 15, 2019

(54) CABINET ASSEMBLY

(71) Applicant: Chia-Ming Liu, Douliou City (ZW)

(72) Inventor: Chia-Ming Liu, Douliou City (ZW)

(21) Appl. No.: 16/035,237

(22) Filed: Jul. 13, 2018

(30) Foreign Application Priority Data
Feb. 13, 2018 (CN) 2018202569186

(51) Int. Cl. E06C 1/00; E06C 1/397; A47B 81/00

(52) U.S. Cl. CPC E06C 1/005; A47B 81/00; E06C 1/397

(57) ABSTRACT

A cabinet assembly includes a cabinet unit, a guide rod and a sliding ladder. The cabinet unit has a top surface that has two opposite top peripheral edges extending in a first direction. The guide rod is mounted to the cabinet unit and is disposed adjacent to one of the top peripheral edges. The sliding ladder extends in a second direction that is transverse to the first direction, and has at least one hook portion that is removably and slidably hooked to the guide rod, and a plurality of rung portions that are arranged in a spaced apart manner in the second direction.

### CROSS-REFERENCE TO RELATED APPLICATION

This application claims priority of Chinese Patent Application No. 201820256918.6, filed on Feb. 13, 2018.

### FIELD

The disclosure relates to a cabinet assembly, and more particularly to a cabinet assembly that includes a sliding ladder.

### BACKGROUND

Generally, a conventional tool cabinet or a locker used in an industrial plant, as disclosed in Taiwanese Utility Model Patent Nos. M519442 and M444764, is designed to have a height in conformity with a human height, in order for a user to put in or to retrieve objects from the tool cabinet or the locker conveniently. However, a storage space thereof is consequentially limited in volume.

If the tool cabinet or the locker is designed to be heightened to provide more storage space, the user may have to use a ladder or a chair to put in or to take out the objects that are elevated from normal reach. Aside from inconvenience of use, because the ladder or the chair is generally not secured to the tool cabinet or the locker, the user may be at risk to fall from the ladder or the chair.

### SUMMARY

Therefore, an object of the disclosure is to provide a cabinet assembly that can alleviate at least one of the drawbacks of the prior art.

According to the disclosure, a cabinet assembly includes a cabinet unit, a guide rod and a sliding ladder.

The cabinet unit has a top surface that has two opposite top peripheral edges substantially extending in a first direction.

The guide rod is mounted to the cabinet unit and is disposed adjacent to one of the top peripheral edges.

The sliding ladder extends in a second direction that is transverse to the first direction, and has at least one hook portion that is removably and slidably hooked to the guide rod, and a plurality of rung portions that are arranged in a spaced apart manner in the second direction.

### BRIEF DESCRIPTION OF THE DRAWINGS

Other features and advantages of the disclosure will become apparent in the following detailed description of the embodiment with reference to the accompanying drawings, of which:

FIG. 1 is a perspective view of an embodiment of a cabinet assembly according to the disclosure, illustrating a sliding ladder of the cabinet assembly in use;

FIG. 2 is a partly enlarged view of the embodiment, illustrating the sliding ladder having hook portions that are hooked to a guide rod of the cabinet assembly;

FIG. 3 is another partly enlarged view of the embodiment, illustrating the sliding ladder having two casters;

FIG. 4 is a front view of the embodiment;

FIG. 5 is a perspective view of the embodiment, illustrating the sliding ladder secured to a lateral side surface of the cabinet assembly when not in use; and

FIG. 6 is a front view of FIG. 5.

### DETAILED DESCRIPTION

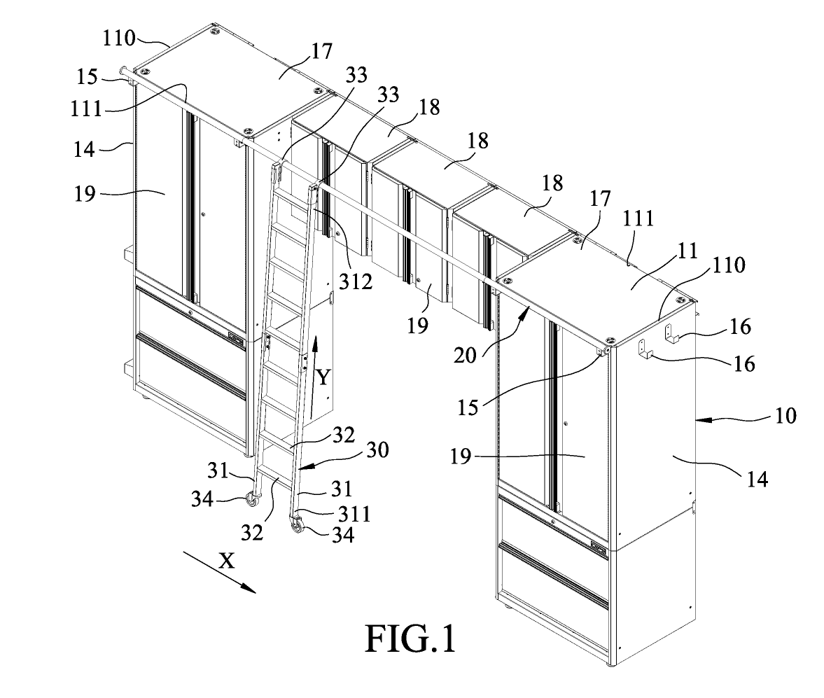

Referring to FIG. 1, a cabinet assembly according to an embodiment of the disclosure includes a cabinet unit 10, a guide rod 20 and a sliding ladder 30.

The cabinet unit 10 has a top surface 11 that has two opposite top peripheral edges 111 substantially extending in a first direction (X), and two opposite lateral edges 110 interconnecting the top peripheral edges 111. The cabinet unit 10 further has two opposite lateral surfaces 14 that extend downwardly and respectively from the lateral edges 110 of the top surfaces 11, a plurality of first fixing members 15 that are spaced apart from each other in the first direction (X), and four positioning members 16 (only two are visible in the drawings) disposed on the lateral surfaces 14.

In this embodiment, one of the top peripheral edges 111 of the top surface 11 is disposed in front of the other one of the top peripheral edges 111. Specifically, the cabinet unit 10 includes two cabinets 17, and three cabinets 18 disposed between the cabinets 17. The cabinets 17, 18 are arranged in the first direction (X). Each of the cabinets 17, 18 has a top surface. The top surfaces of the cabinets 17, 18 cooperatively form the top surface 11 of the cabinet unit 10. The lateral edges 110 of the cabinet unit 10 are formed respectively on the cabinets 17, and the lateral surfaces 14 of the cabinet unit 10 are formed respectively on the cabinets 17. Each of the cabinets 17, 18 further has a door 19. The doors 19 of the cabinets 17, 18 are disposed adjacent to the front one of the top peripheral edges 111. Each of the cabinets 18 has a width in a front-rear direction smaller than that of each of the cabinets 17.

The first fixing members 15 are disposed on the cabinets 17 and are fixed to the front one of the top peripheral edges 111. Each of the first fixing members 15 has an L-shaped cross section. Specifically, each of the first fixing members 15 has a first segment protruding forwardly from the front one of the top peripheral edges 111, and a second segment extending upwardly from a distal end of the first segment. Two positioning members 16 are disposed on one of the lateral surfaces 14 and proximal to the top surface 11 of the cabinet unit 10. The other two positioning members 16 are disposed on the other one of the lateral surfaces 14 and proximal to the top surface 11 of the cabinet unit 10. Each of the positioning members 16 has an L-shaped cross section. Specifically, each of the positioning members 16 has a first segment protruding forwardly from the corresponding one of the lateral surfaces 14, and a second segment extending upwardly from a distal end of the first segment.

The guide rod 20 is mounted to the cabinet unit 10. Specifically, the guide rod 20 is fixed to the fixing members 15 and is disposed adjacent to the front one of the top peripheral edges 111. In this embodiment, the guide rod 20 is a telescopic rod having a plurality of rod sections. Also, in this embodiment, the door 19 of each of the cabinets 17, 18 is disposed at a side of the cabinets 17, 18 proximate to the guide rod 20. To be more specific, a distance between the doors 19 of each of the cabinets 17 and the guide rod 20 is smaller than that between the doors 19 of each of the cabinets 18 and the guide rod 20.

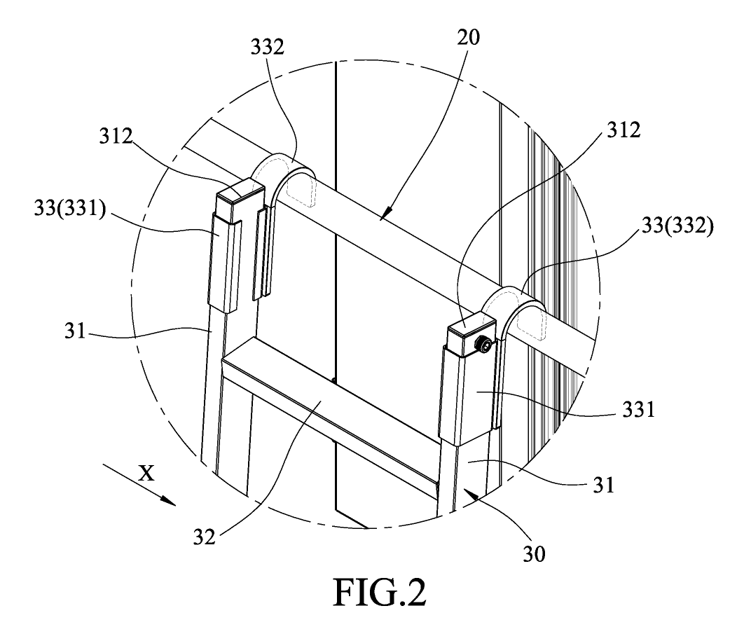

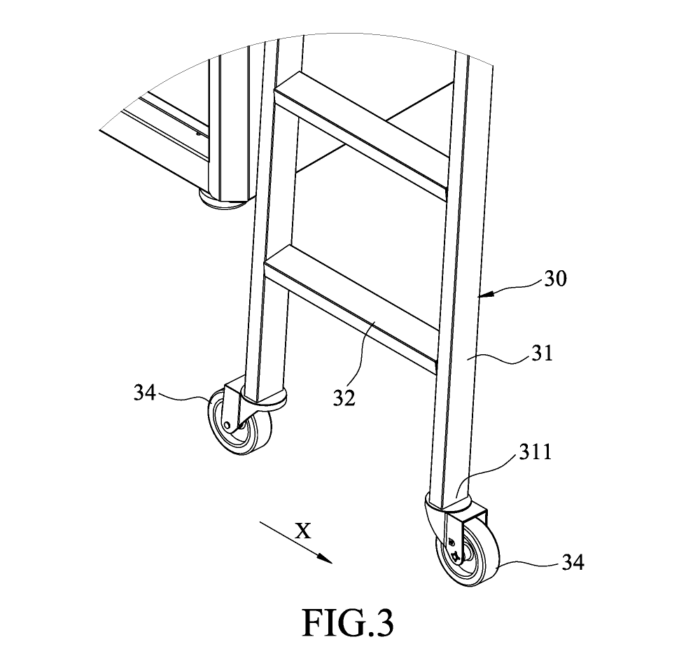

The sliding ladder 30 extends in a second direction (Y) that is transverse to the first direction (X) and the front-rear direction, and is slidable relative to the guide rod 20. In this embodiment, the sliding ladder 30 has two hook portions 33, two legs 31, a plurality of rung portions 32, and two casters 34. The hook portions 33 are removably and slidably hooked to the guide rod 20. The legs 31 extend in the second direction (Y). Each of the legs 31 has a bottom end 311 and a top end 312 that is opposite to the bottom end 311 and that is connected to a respective one of the hook portions 33. The rung portions 32 are arranged in a spaced apart manner in the second direction (Y). Each of the rung portions is rod-shaped and has opposite ends connected respectively to the legs 31. The casters 34 are respectively connected to the bottom ends 311 of the legs 31 (see FIG. 3). Specifically, each of the hook portions 33 has a sleeve section 331 fixedly connected to the top end 312 of the respective leg 31, and an inverted U-shaped curved section 332 that is fixedly connected to the sleeve section 331 and that is slidably hooked to the guide rod 20 (see FIG. 2).

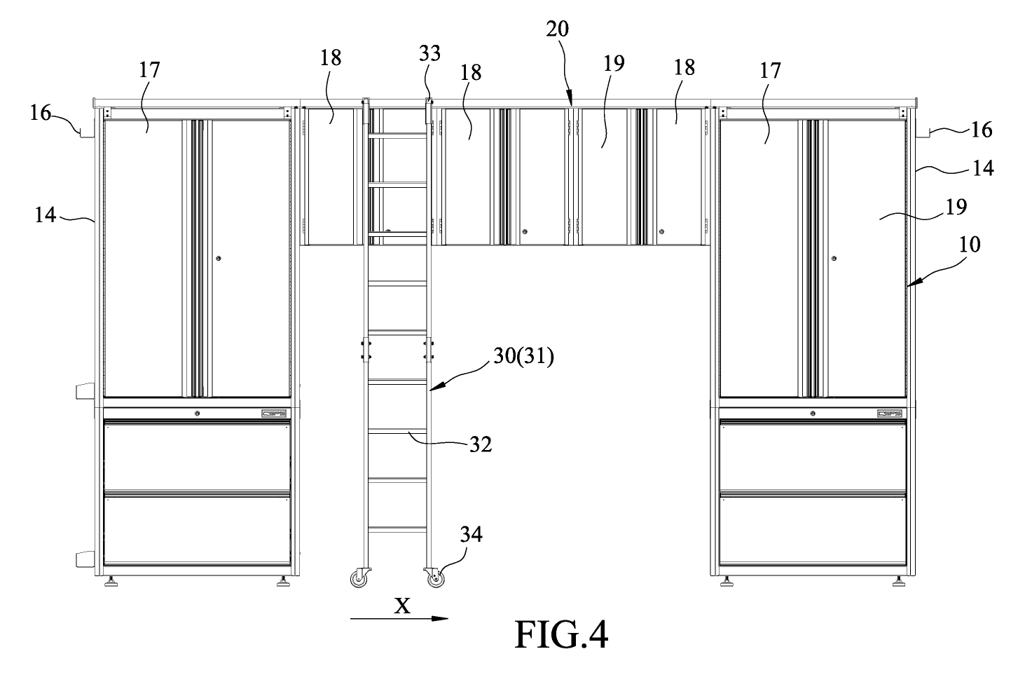

FIGS. 1 to 4 illustrate the cabinet assembly of the disclosure in a use state. Because the curved sections 332 of the hook portions 33 are slidably hooked to the guide rod 20, the sliding ladder 30 is pushed by a user to move along the guide rod 20 to a selected position relative to the cabinet unit 10 through the casters 34. By virtue of the rung portions 32 arranged in the second direction (Y), the user can climb the sliding ladder 30 at a selected height to open a corresponding one of the doors 19, thereby taking an object stored in a corresponding one of the cabinets 17, 18. Because the hook portions 33 are hooked to the guide rod 20, the sliding ladder 30 is secured to the cabinet unit 10, such that the user safety is ensured during climbing the sliding ladder 30.

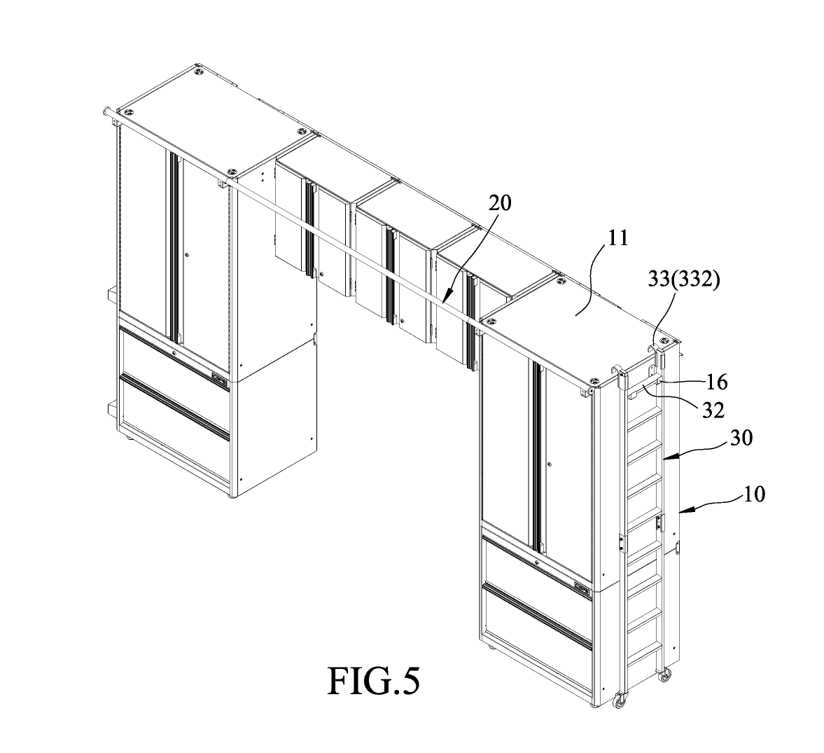

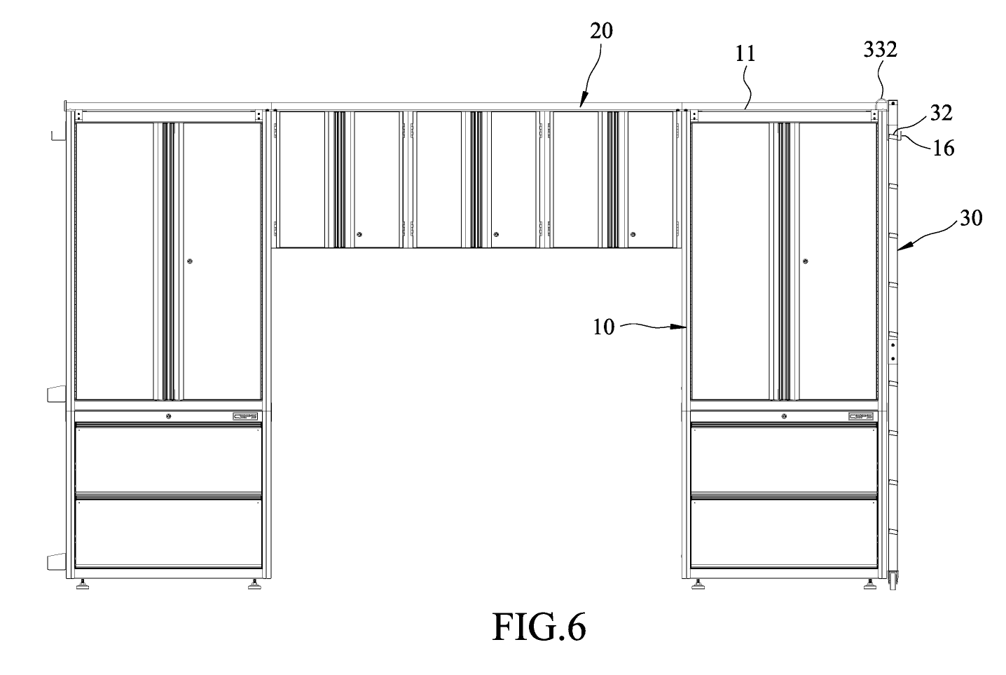

Referring to FIGS. 5 and 6, when the sliding ladder 30 is not in use, the sliding ladder 30 is first removed from the guide rod 20 by removing the curved sections 332 of the hook portions 332 from the guide rod 20. Afterwards, a top one of the rung portions 32 is laid on the positioning members 16 on one of the lateral surfaces 14, and the curved sections 332 of the hook portions 33 abut the top surface 11, such that the sliding ladder 30 is stably stored on and secured to the one of the lateral surfaces 14.

In addition, by virtue of sliding ladder 30 slidably connected to the guide rod 20 via the hook portions 33, the user can easily access objects placed on the top surface 11, thereby increasing space usage.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A cabinet assembly comprising:
a cabinet unit having a top surface that has two opposite top peripheral edges substantially extending in a first direction;
a guide rod mounted to said cabinet unit and disposed adjacent to one of said top peripheral edges; and
a sliding ladder extending in a second direction that is transverse to the first direction, and having at least one hook portion that is removably and slidably hooked to said guide rod, and a plurality of rung portions that are arranged in a spaced apart manner in the second direction.

2. The cabinet assembly as claimed in claim 1, wherein said cabinet unit further has a plurality of first fixing members spaced apart from each other in the first direction and fixed to said one of said top peripheral edges, said guide rod being fixed to said fixing members.

3. The cabinet assembly as claimed in claim 2, wherein each of said fixing members has an L-shaped cross section.

4. The cabinet assembly as claimed in claim 1, wherein said cabinet unit includes a plurality of cabinets, each of said cabinets having a top surface and a door, said top surfaces of said cabinets cooperatively forming said top surface of said cabinet unit, said door of each of said cabinets being disposed proximate to said guide rod.

5. The cabinet assembly as claimed in claim 1, wherein:
said at least one hook portion includes two hook portions;
said sliding ladder further has
two legs extending in the second direction, each of said legs having a bottom end and a top end that is opposite to said bottom end and that is connected to a respective one of said hook portions, and
two casters respectively connected to said bottom ends of said legs; and
each of said rung portions is rod-shaped and has opposite ends connected respectively to said legs.

6. The cabinet assembly as claimed in claim 1, wherein:
said one of said top peripheral edges of said top surface is disposed in front of the other one of said top peripheral edges;
said top surface further has two opposite lateral edges interconnecting said top peripheral edges; and
said cabinet unit further has two opposite lateral surfaces extending downwardly and respectively from said lateral edges of said top surfaces, and at least one positioning member disposed on one of said lateral surfaces, said sliding ladder being laid on said at least one positioning member for storage when said sliding ladder is removed from said guide rod.

7. The cabinet assembly as claimed in claim 6, wherein said at least one positioning member includes two positioning members, each of said positioning members having an L-shaped cross section.
